(19) United States
(12) Patent Application Publication
(10) Pub. No.: US 2024/0296010 A1
(43) Pub. Date: Sep. 5, 2024

(54) Processing Unit

(71) Applicant: Graphcore Limited, Bristol (GB)

(72) Inventor: Thomas BROWN, Bristol (GB)

(21) Appl. No.: 18/591,349

(22) Filed: Feb. 29, 2024

(30) Foreign Application Priority Data
Mar. 2, 2023 (GB) 2303048.9

(51) Int. Cl. G06F 7/499; G06F 7/523; G06F 7/556

(52) U.S. Cl. CPC G06F 7/49915; G06F 7/523; G06F 7/556

(57) ABSTRACT

A processing unit is provided with circuitry enabling execution quick evaluation of an exponential function. A multiplier circuit is used to multiply the input operand by log₂(e), such that a result for the exponential function may be determined by evaluating 2^{i+f}, where i is an integer part of a fixed-point number and f is a fractional part of the fixed-point number. A lookup table is used for providing an estimate for 2^{f} based on the l MSBs of f. The lookup entries are provided according to a function such that the estimates for 2^{f} are provided without bias towards either zero or infinity in the result. In other words, the maximum multiplicative error for each entry of the lookup table is the same in both negative and positive directions. In this way, statistical errors in the evaluation of a large number of exponential functions may be avoided.

### CROSS-REFERENCE TO RELATED APPLICATIONS

The present application claims priority to United Kingdom Patent Application No. GB2303048.9 filed Mar. 2, 2023, which is incorporated by reference herein in its entirety.

### TECHNICAL FIELD

The present disclosure relates to a processing unit, and in particular to a processing unit configured to evaluate an exponential function of an operand.

### BACKGROUND

In computing, a processing unit performs arithmetic operations on bit sequences that are used to represent numbers. The particular representation of the bit sequence determines how a bit sequence is interpreted.

One form of representation is the floating-point representation, which is often used to approximately represent real numbers. The floating-point representation comprises 3 separate components, i.e., a sign component, a mantissa component, and an exponent component. In the single-precision (i.e., 32-bit) floating point representation according to the IEEE 754 standard, the sign component consists of a single bit, the exponent consists of 8 bits, and the mantissa consists of 23 bits. In the half-precision (i.e., 16-bit) floating-point representation, the sign component consists of a single bit, the mantissa consists of 10 bits, and the exponent consists of 5 bits. In most cases, a number is given from these 3 components by the following formula:

$${( - 1 )}^{signbit} \times I . mantissa \times {2}^{exponentbits - offset}$$

The displayed “offset” to the exponent is dependent upon the number of bits used to represent the exponent, which is dependent upon the precision level. In the single-precision representation, the offset is equal to 127. In the half-precision format, the offset is equal to 15.

Here “I” is an implicit bit, which is derived from the exponent. In the case that the exponent bit sequence consists of anything other than all zeros or all ones, the implicit bit is equal to one and the number is known as a “Norm”. In this case, the floating-point number is given by:

$${( - 1 )}^{signbit} \times 1. mantissa \times {2}^{exponentbits - offset}$$

In the case that the exponent bit sequence consists of all zeros, the implicit bit is equal to zero and the number is known as a “denorm”. In this case, the floating-point number is given by:

$${( - 1 )}^{signbit} \times 0. mantissa \times {2}^{exponentbits - offset}$$

The denorms are useful, since they allow smaller numbers to be represented than would otherwise be representable by the limited number of exponent bits.

The other circumstance—in which the exponent bit sequence consists of all ones—may be used to represent special cases, e.g. ±infinity or NaN (not a number). NaN is a numeric data type value representing an undefined or unrepresentable value. The presence of a NaN in the results of a calculation is often taken to signal an exception.

Another form of representation is the integer representation. The integer may be signed, in which case a single bit of the bit sequence is used to represent the sign of the number, with the remaining bits of the bit sequence used to represent the magnitude of the number. Alternatively, the integer may be unsigned, in which all of the bits of the bit sequence are used to represent the magnitude of the number.

The floating-point representation may be used to represent numbers in implementations of neural network processing. An implementation of neural networks involves the storage and manipulation of such floating-point numbers. Neural networks are used in the field of machine learning and artificial intelligence. Neural networks comprise arrangements of sets of nodes which are interconnected by links and which interact with each other. The principles of neural networks in computing are based on information about how electrical stimuli convey information in the human brain. For this reason, the nodes are often referred to as neurons. They may also be referred to as vertices. The links are sometimes referred to as edges. The network can take input data and certain nodes perform operations on the data. The result of these operations is passed to other nodes. The output of each node is referred to as its activation or node value. Each link is associated with a weight. A weight defines the connectivity between nodes of the neural network. Many different techniques are known by which neural networks are capable of learning, which takes place by altering values of the weights.

FIG. 1 shows an extremely simplified version of one arrangement of nodes in a neural network. This type of arrangement is often used in learning or training and comprises an input layer of nodes, a hidden layer of nodes and an output layer of nodes. In reality, there will be many nodes in each layer, and nowadays there may be more than one layer per section. Each node of the input layer Ni is capable of producing at its output an activation or node value, which is generated by carrying out a function on data provided to that node. A vector of node values from the input layer is scaled by a vector of respective weights at the input of each node in the hidden layer, each weight defining the connectivity of that particular node with its connected node in the hidden layer. In practice, networks may have millions of nodes and be connected multi-dimensionally, so the vector is more often a tensor. The weights applied at the inputs of the node Nh are labelled w0 . . . w2. Each node in the input layer is connected at least initially to each node in the hidden layer. Each node in the hidden layer can perform an activation function on the data which is provided to it and can generate similarly an output vector which is supplied to each of the nodes No in the output layer No. Each node weights its incoming data, for example by carrying out the dot product of the input activations of the node and its unique weights for the respective incoming links. It then performs an activation function on the weighted data. The activation function can be, for example, a sigmoid. See FIG. 1A. The network learns by operating on data input at the input layer, assigning weights to the activations from each node and acting on the data input to each node in the hidden layer (by weighting it and performing the activation function). Thus, the nodes in the hidden layer operate on the weighted data and supply outputs to the nodes in the output layer. Nodes of the output layer may also assign weights. Each weight is characterised by a respective error value. Moreover, each node may be associated with an error condition. The error condition at each node gives a measure of whether the error in the weight of the node falls below a certain level or degree of acceptability. There are different learning approaches, but in each case, there is a forward propagation through the network from left to right in FIG. 1, a calculation of overall error, and a backward propagation from right to left in FIG. 1 through the network of the error. In the next cycle, each node takes into account the back-propagated error and produces a revised set of weights. In this way, the network can be trained to perform its desired operation.

Certain well-known functions, such as exponentials, have applications in neural network processing. For example, when computing certain types of activation functions in a neural network, a processing unit may evaluate exponential functions.

### SUMMARY

When designing the circuitry within a processing unit for evaluating an exponential function, there are a number of technical considerations. One such consideration is the speed with which the exponential function may be evaluated. An instruction for evaluating an exponential function that takes several processor thread cycles to complete consumes additional processor time that slows down the running of the program.

Another consideration is the accuracy with which the exponential function is evaluated. Some applications may require a very high level of accuracy, whereas others may tolerate higher levels of inaccuracy. However, even in certain applications that tolerate a given level of inaccuracy, there may still be a requirement to avoid bias towards overestimates or underestimates. Such biases, when many exponential results are combined together (e.g., in neural network processing), can result in statistical errors leading, e.g., to poorly trained neural networks.

Therefore, if circuitry within a processing unit is to be provided for quickly providing estimates for the exponential of an operand, it may be important to avoid any bias towards overestimating or underestimating the exponential result.

According to a first aspect, there is provided a processing unit comprising a hardware module for evaluating an exponential function of an operand, the operand being a number in a floating-point format, the processing unit comprising: a multiplier circuit configured to perform a multiplication operation; a look up table having a plurality of entries, each of which is accessible using a respective key k to extract an output given by 2^{k+2}^{^{−l−1}}, where l is the bit length of each key; a barrel shifter; an output register; and circuitry configured to: supply the operand at an input of the multiplier circuit to multiply the operand by a fixed multiplicand, log₂(e), to generate a multiplication result; convert the multiplication result to a fixed-point number by supplying the multiplication result to the barrel shifter to shift a mantissa of the multiplication result by an amount dependent upon an exponent of the multiplication result; extract a fractional part f from the fixed-point number; search the lookup table using the l most significant bits of the fractional part to obtain an estimate for 2^{f}; and store in the output register, as a mantissa of a result of the exponential function, a value dependent upon the estimate for 2^{f}.

The processing unit is provided with circuitry enabling quick evaluation of an exponential function. In particular, execution of an instruction for evaluating the exponential function may complete in a single thread cycle. The multiplier circuit is used to multiply the input operand by log₂(e), such that a result for the exponential function may be determined by evaluating 2^{i+f}, where i is an integer part of a fixed-point number and f is a fractional part of the fixed-point number. A lookup table is used for providing an estimate for 2^{f} based on the l MSBs of f. The lookup entries are provided according to a function such that the estimates for 2^{f} are provided without bias towards either zero or infinity in the result. In other words, the maximum multiplicative error for each entry of the lookup table is the same in both negative and positive directions. In this way, statistical errors in the evaluation of a large number of exponential functions may be avoided. Furthermore, this implementation is faster as compared to alternative implementations that may require additional processing—e.g. the use of multiple lookup tables and the required processing to combine the outputs of those multiple look tables—to produce more accurate results.

According to a second aspect, there is provided a method for evaluating an exponential function of an operand of an instruction, the operand being a number in a floating-point format, the method comprising: supplying the operand at an input of a multiplier circuit to multiply the operand by a fixed multiplicand, log₂(e), to generate a multiplication result; converting the multiplication result to a fixed-point number by supplying the multiplication result to a barrel shifter to shift a mantissa of the multiplication result by an amount dependent upon an exponent of the multiplication result; extracting a fractional part f from the fixed-point number; searching the lookup table using the I most significant bits of the fractional part to obtain an estimate for 24, the lookup table having a plurality of entries, each of which is accessible using a respective key k to extract an output given by 2^{k+2}^{^{−l−1}}, where l is the bit length of each key; and storing in an output register, as a mantissa of a result of the exponential function, a value dependent upon the estimate for 2^{f}.

In some embodiments, the value dependent upon the estimate for 2^{f} is the estimate for 2^{f}.

In some embodiments, the method comprises examining an integer part of the fixed-point number to determine whether the result of the exponential function is in the subnormal range; and in response to the subnormal check logic determining that the result is not in the subnormal range, storing in the output register, as the mantissa of the result, the estimate for 2^{f}.

In some embodiments, the method comprises determining that the result of the exponential function is a subnormal number in response to determining that an integer part of the fixed-point number is less than a predefined number, wherein the method comprises receiving at a further barrel shifter, the estimate for 2^{f} from the lookup table and applying right-shift to the estimate for 2^{f} in proportion to the difference between the predefined number and the integer part, wherein the value dependent upon the estimate for 2^{f} comprises the right-shifted estimate for 2^{f}.

In some embodiments, the method comprises, in response to determining that a sign bit of the operand indicates that the operand is negative, determining the fixed-point number by supplying the shifted mantissa from the barrel shifter to inversion circuitry configured to invert bits of the shifted mantissa.

In some embodiments, the method comprises determining the fixed-point number without adding one to the least significant bit of the inverted bits.

In some embodiments, the method comprises: in response to determining that a sign bit of the operand indicates that the operand is positive, determining the fixed-point number by extracting the shifted mantissa from the barrel shifter.

In some embodiments, the fixed-point number comprises a set of bits derived from the shifted mantissa and a sign bit.

In some embodiments, the method comprises: extracting an integer part from the fixed-point number; and storing in the output register, as an exponent of the result, a value dependent upon the integer part.

In some embodiments, the method comprises adding a bias value for the floating-point format to the integer part to provide the value dependent upon the integer part.

In some embodiments, the method comprises examining an integer part of the fixed-point number to determine whether the result of the exponential function is in the subnormal range; and in response to the subnormal check logic determining that the result is in the subnormal range, storing in the output register, as the exponent of the result, a string of zeros.

In some embodiments, the method comprises processing the operand to produce the exponential result in a single processor thread cycle of the processing unit.

In some embodiments, the method comprises: determining an input for a node of a neural network; and applying an activation function to the input to determine an output of the node, including executing one or more instances of the instruction.

In some embodiments, the method comprises shifting the mantissa of the multiplication result by an amount dependent upon a difference between the exponent and a maximum exponent value that avoids overflow of the result of the exponential function.

In some embodiments, the method comprises shifting the mantissa of the multiplication result to produce the fixed-point number, including removing a number of least significant bits from the mantissa of the multiplication result.

In some embodiments, the l most significant bits of the fractional part consists of fewer bits than the mantissa of the multiplication result.

### BRIEF DESCRIPTION OF THE DRAWINGS

For a better understanding of the present invention and to show how the same may be carried into effect, reference will now be made by way of example to the accompanying Figures in which:

FIG. 1 is a simplified schematic view of a neural net;

FIG. 1A is a simplified schematic view of a neuron;

FIG. 2 shows a schematic view of a processing unit;

FIG. 3 shows a schematic view of a hardware module;

FIG. 4 shows circuitry within the hardware module;

FIG. 5 illustrates the application of right shift to a mantissa by a barrel shifter of the hardware module;

FIG. 6 illustrates the inversion of bits of the mantissa by invertors of the hardware module;

FIG. 7 illustrates a function f→2^{f} and two example entries of a lookup table in which the key for searching the lookup table is 5 bits long;

FIGS. 8A and 8B illustrates a method according to example embodiments; and

FIG. 9 schematically illustrates a scheme of interleaved time slots.

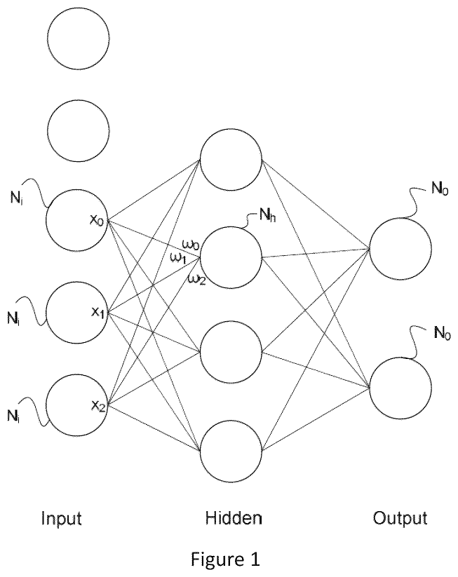

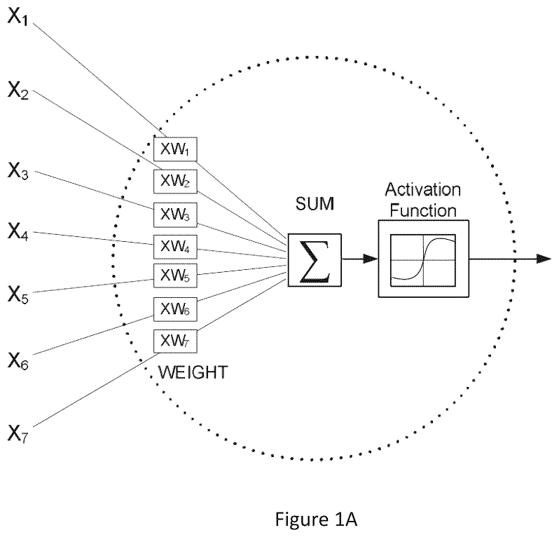

### DETAILED DESCRIPTION

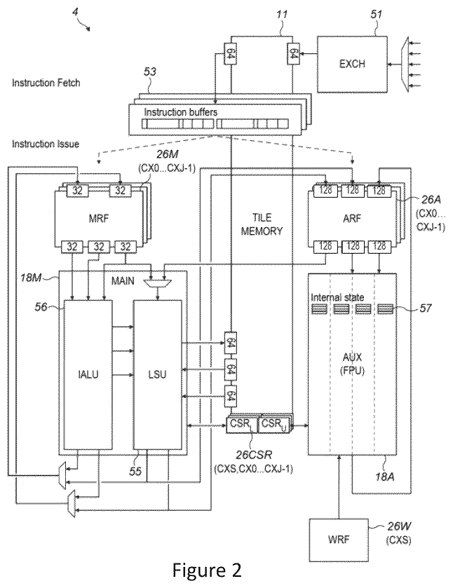

Embodiments are implemented in a processing unit. An example of a processing unit 4 comprising execution units is described in more detail with reference to FIG. 2. In some embodiments, the processing unit 4 may take the form of a tile belonging to a number of tiles formed together on a chip. An example of such a multi-tile chip is described in more detail in our earlier application U.S. application Ser. No. 16/527,410, which is incorporated by reference herein in its entirety.

Reference is made to FIG. 2, which illustrates an example of the processing unit 4 including detail of the execution units 18A, 18M and context registers 26. The processing unit 4 shown includes a weights register file 26W, and so may be specially adapted for machine learning applications, in which machine learning models are trained by adjusting the weights for those models. However, embodiments of the application are not limited to machine learning applications, but are more broadly applicable.

The processing unit 4 described is a multi-threaded processor capable of executing M thread concurrently. The processing unit 4 is able to support execution of M worker threads and one supervisor thread, where the worker threads perform arithmetic operations on data to generate results and the supervisor thread co-ordinates the worker threads and controls the synchronisation, sending and receiving functionality of the processing unit 4.

The processing unit 4 comprises a respective instruction buffer 53 for each of M threads capable of being executed concurrently. The context registers 26 comprise a respective main register file (MRF) 26M for each of M worker contexts and a supervisor context. The context registers further comprise a respective auxiliary register file (ARF) 26A for at least each of the worker contexts. The context registers 26 further comprise a common weights register file (WRF) 26W, which all the currently executing worker threads can access to read from. The WRF may be associated with the supervisor context in that the supervisor thread is the only thread that can write to the WRF. The context registers 26 may also comprise a respective group of control state registers 26CSR for each of the supervisor and worker contexts. The execution units comprise a main execution unit 18M and an auxiliary execution unit 18A. The main execution unit 18M comprises a load-store unit (LSU) 55 and an integer arithmetic logic unit (IALU) 56. The auxiliary execution unit 18A comprises at least a floating-point arithmetic unit (FPU).

In each of the J interleaved time slots S0 . . . SJ-1, the scheduler 24 controls the fetch stage 14 to fetch at least one instruction of a respective thread from the instruction memory 11, into the respective one of the J instruction buffers 53 corresponding to the current time slot. In embodiments, each time slot is one execution cycle of the processor, though other schemes are not excluded (e.g. weighted round-robin). In each execution cycle of the processing unit 4 (i.e. each cycle of the processor clock which clocks the program counter) the fetch stage 14 fetches either a single instruction or a small “instruction bundle” (e.g. a two-instruction bundle or four-instruction bundle), depending on implementation. Each instruction is then issued, via the decode stage 16, into one of the LSU 55 or IALU 56 of the main execution unit 18M or the FPU of the auxiliary execution unit 18A, depending on whether the instruction (according to its opcode) is a memory access instruction, an integer arithmetic instruction or a floating-point arithmetic instruction, respectively. The LSU 55 and IALU 56 of the main execution unit 18M execute their instructions using registers from the MRF 26M, the particular registers within the MRF 26M being specified by operands of the instructions. The FPU of the auxiliary execution unit 18A performs operations using registers in the ARF 26A and WRF 26W, where the particular registers within the ARF are specified by operands of the instructions. In embodiments, the registers in the WRF may be implicit in the instruction type (i.e., pre-determined for that instruction type). The auxiliary execution unit 18A may also contain circuitry in the form of logical latches internal to the auxiliary execution unit 18A for holding some internal state 57 for use in performing the operations of one or more of the types of floating-point arithmetic instruction.

In embodiments that fetch and execute instructions in bundles, the individual instructions in a given instruction bundle are executed simultaneously, in parallel down independent pipelines 18M, 18A (shown in FIG. 2). In embodiments that execute bundles of two instructions, the two instructions may be executed simultaneously down respective auxiliary and main pipelines. In this case, the main pipeline is arranged to execute types of instruction that use the MRF, and the auxiliary pipeline is used to execute types of instruction that use the ARF. The pairing of instructions into suitable complementary bundles may be handled by the compiler.

Each worker thread context has its own instance of the main register file (MRF) 26M and auxiliary register file (ARF) 26A (i.e., one MRF and one ARF for each of the barrel-threaded slots). Functionality described herein in relation to the MRF or ARF is to be understood to operate on a per context basis. However, there is a single, shared weights register file (WRF) shared between the threads. Each thread can access the MRF and ARF of only its own context 26. However, all currently-running worker threads can access the common WRF. The WRF thus provides a common set of weights for use by all worker threads. In embodiments, only the supervisor can write to the WRF, and the workers can only read from the WRF.

The instruction set of the processing unit 4 includes at least one type of load instruction whose opcode, when executed, causes the LSU 55 to load data from the data memory 22 into the respective ARF, 26A of the thread in which the load instruction was executed. The location of the destination within the ARF is specified by an operand of the load instruction. Another operand of the load instruction specifies an address register in the respective MRF 26M, which holds a pointer to an address in the data memory 22 from which to load the data. The instruction set of the processing unit 4 also includes at least one type of store instruction whose opcode, when executed, causes the LSU 55 to store data to the data memory 22 from the respective ARF of the thread in which the store instruction was executed. The location of the source of the store within the ARF is specified by an operand of the store instruction. Another operand of the store instruction specifies an address register in the MRF, which holds a pointer to an address in the data memory 22 to which to store the data. In general, the instruction set may include separate load and store instruction types, and/or at least one load-store instruction type which combines the load and store operations in a single instruction.

In response to the opcode of the relevant type of arithmetic instruction, the arithmetic unit (e.g. FPU) in the auxiliary execution unit 18A performs an arithmetic operation, as specified by the opcode, which comprises operating upon the values in the specified source register(s) in the threads' respective ARF and, optionally, the source register(s) in the WRF. It also outputs a result of the arithmetic operation to a destination register in the thread's respective ARF as specified explicitly by a destination operand of the arithmetic instruction.

It will be appreciated that the labels “main” and “auxiliary” are not necessarily limiting. In embodiments, they may be any first register file (per worker context), second register file (per worker context) and shared third register file (e.g., part of the supervisor context but accessible to all workers). The ARF 26A and auxiliary execution unit 18 may also be referred to as the arithmetic register file and arithmetic execution unit since they are used for arithmetic instructions (or at least the floating-point arithmetic). The MRF 26M and auxiliary execution unit 18 may also be referred to as the memory address register file and arithmetic execution unit since one of their uses is for accessing memory. The weights register file (WRF) 26W is so-called, because it is used to hold multiplicative weights used in a certain type or types of arithmetic instruction, to be discussed in more detail shortly. E.g. these could be used to represent the weights of nodes in a neural network. Seen another way, the MRF could be called the integer register file as it is used to hold integer operands, whilst the ARF could be called the floating-point register file as it is used to hold floating-point operands. In embodiments that execute instructions in bundles of two, the MRF is the register file used by the main pipeline and the ARF is the register used by the auxiliary pipeline.

In alternative embodiments, however, note that the register space 26 is not necessarily divided into these separate register files for these different purposes. Instead instructions executed through the main and auxiliary execution units may be able to specify registers from amongst the same shared register file (one register file per context in the case of a multithreaded processor). Also the pipeline 13 does not necessarily have to comprise parallel constituent pipelines (e.g., aux and main pipelines) for simultaneously executing bundles of instructions.

The processing unit 4 may also comprise an exchange interface 51 for exchanging data between the memory 11 and one or more other resources, e.g., other instances of the processor and/or external devices, such as a network interface or network attached storage (NAS) device. As discussed above, in embodiments the processing unit 4 may form one of an array of interconnected processor tiles, each tile 4 running part of a wider program. The individual processing units 4 (tiles) thus form part of a wider processor or processing system. The tiles 4 may be connected together via an interconnect subsystem, to which they connect via their respective exchange interface 51. The tiles 4 may be implemented on the same chip (i.e., die) or on different chips, or a combination (i.e., the array may be formed from multiple chips each comprising multiple tiles 4). The interconnect system and exchange interface 51 may therefore comprise an internal (on-chip) interconnect mechanism and/or external (inter-chip) exchange mechanism, accordingly.

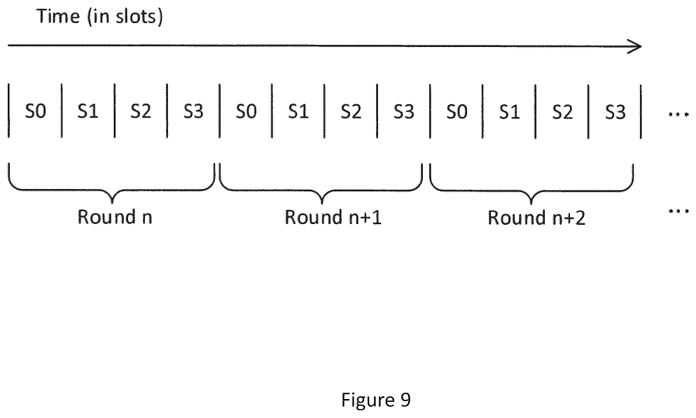

The threads (including the worker threads and the supervisor thread) of the processor are interleaved according to a round-robin scheme. Reference is made to FIG. 9, which illustrates an example interleaving scheme implemented by the scheduler 24. Here the concurrent threads are interleaved according to a round-robin scheme whereby, within each round of the scheme, the round is divided into a sequence of time slots S0, S1, S2 . . . , each for executing a respective thread. Typically, each slot is one processor cycle long and the different slots are evenly sized, though not necessarily so in all possible embodiments, e.g. a weighted round-robin scheme is also possible whereby some threads get more cycles than others per execution round. In general, the barrel-threading may employ either an even round-robin or a weighted round-robin schedule, where in the latter case the weighting may be fixed or adaptive.

Whatever the sequence per execution round, this pattern then repeats, each round comprising a respective instance of each of the time slots. Note, therefore, that a time slot as referred to herein means the repeating allocated place in the sequence, not a particular instance of the time slot in a given repetition of the sequence. Put another way, the scheduler 24 apportions the execution cycles of the pipeline 13 into a plurality of temporally interleaved (time-division multiplexed) execution channels, with each comprising a recurrence of a respective time slot in a repeating sequence of time slots. In the illustrated embodiment, there are four time slots, but this is just for illustrative purposes and other numbers are possible. E.g. in one preferred embodiment there are in fact six time slots.

Whatever the number of time slots the round-robin scheme is divided into, then according to present disclosure, the processing unit 10 comprises one more context register file 26 than there are time slots, i.e., it supports one more context than the number of interleaved timeslots it is capable of barrel-threading.

According to embodiments, a hardware module is provided in the floating-point execution unit 18A for evaluating a new type of instruction, which is referred to herein as the quick exponential instruction (or QUEXP instruction). In response to the execution of the QUEXP instruction, an input floating-point number (which is an operand of the instruction) is multiplied by log₂(e), so as to enable the exponential function to be evaluated by evaluating a base-2 exponential function. The result of the multiplication is supplied to a barrel shifter, so as to be converted from a floating-point number to a fixed-point number, which is then split into integer and fractional parts. The fractional part, f, is used to search a lookup table to obtain an estimate for 2^{f}, which is used to provide the mantissa of the result for the exponential. Each of the entries in the lookup table is accessible using a key k, to extract an output given by 2^{k+2}^{^{−l−1}}, where l is the bit length of each key. Use of such a function for the lookup table provides that the multiplicative errors are balanced for each entry, and so avoids the introduction of statistical errors when the QUEXP instruction is executed a large number of times.

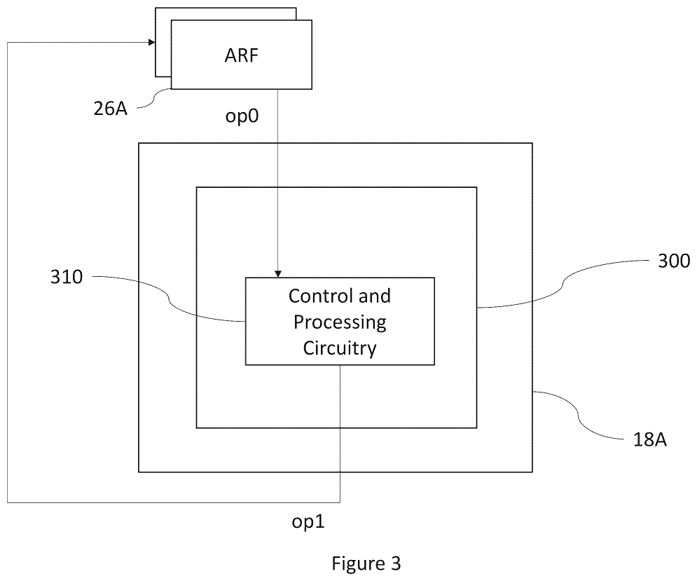

Reference is made to FIG. 3, which illustrates an example of an execution unit 18A according to embodiments. The execution unit 18A comprises a hardware module 300 comprising control and processing circuitry 310 that is configured to evaluate the QUEXP instruction. The control and processing circuitry 310 is configured to perform the operations described herein when the QUEXP instruction is executed by the execution unit 18A. The control and processing circuitry 310 comprises at least wires, latches, multiplexers, barrel shifters, a multiplier, addition circuitry, and invertors for implementing the processing of the FP number to produce the result.

Prior to execution of the QUEXP instruction, an FP value (shown as op0) serving as an input operand for the QUEXP instruction is loaded into an ARF 26A. This load operation is performed in response to the execution of a load instruction by the LSU 55. In response to execution of an instance of the QUEXP instruction, the input FP value is provided to the control and processing circuitry 310 from the ARF 26A. The control and processing circuitry 310 determines an estimate for the exponential of the input FP value and outputs this estimate for storage in one of the ARFs.

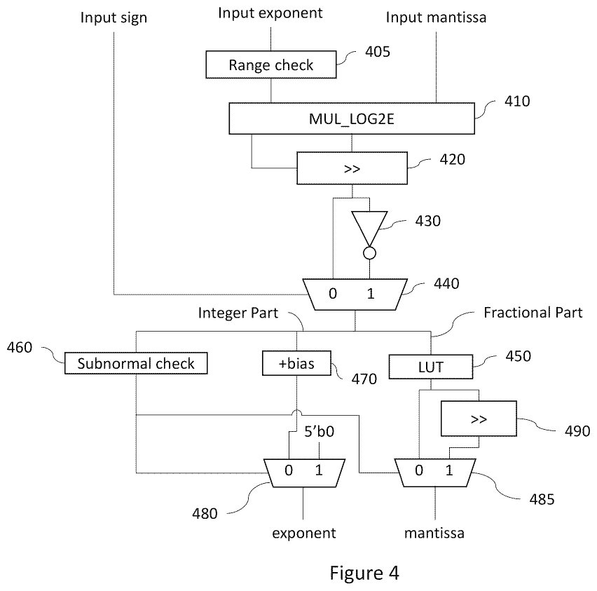

Reference is made to FIG. 4, which illustrates the logic and flow of data within the circuitry 310 for determining the estimate for the exponential function. The control circuitry (not shown in FIG. 4) is configured to control the movement of data between the logic for processing that data. FIG. 4 illustrates some of the components of circuitry 310. However, additional components may also be present. In particular, registers may be present between different ones of the components shown in FIG. 4, where these registers are used for storing data that is passed between the components. In this case, the processing performed by components that are separated by the registers may correspond to different pipeline stages.

The mantissa (shown as the input mantissa), exponent (shown as the input exponent), and sign (input sign) of the FP input value are all shown in FIG. 4. In the following description, examples are given in which the FP input value and the result of the exponential function are in half-precision format. However, different versions of the QUEXP instruction may be executed by the execution unit 18A.

At the start of the process, the exponent is subject to a range check at logic 405. Given that the result of the exponential function must fall within the representable range for the relevant FP format, there is a limit to how large the exponent of the input may be, so as to avoid overflow conditions in the result. In the case that the input is in half-precision format, if the exponent is greater than or equal to 5, then e^{x} is beyond the range of half precision. The logic 405 examines the input exponent and determines if the exponent is within range. If the exponent is determined to be out of range, and the sign bit is positive, then the circuitry 310 outputs a FP number representing +infinity as the result. If the exponent is determined to be out of range, and the sign bit is negative, then the circuitry 310 outputs a FP number representing zero as the result. If the exponent is within range, then the circuitry 310 proceeds to estimate the exponential result by applying the novel QUEXP method.

The processing circuitry 310 comprises multiplication circuitry 410 for multiplying the input FP number by the constant, log₂(e). Since 2^{log}^{₂}^{(e)}=e, if the input floating number is denoted by x, it is seen that the exponential of x can be expressed as:

$${e}^{x} = {( {2}^{{log}_{2} ( e )} )}^{x} = {2}^{x . {log}_{2} ( e )} \qquad Equation 1$$

Hence, by multiplying x by log₂(e), it is possible to evaluate the base-e exponential function by evaluating a base-2 exponential function.

Once the value of x·log₂(e) is obtained from the multiplication circuitry 410, the control circuitry 310 provides that value to the barrel shifter 420 to convert the multiplication result x·log₂(e) to a fixed-point number. As part of the conversion of x·log₂(e) from a floating-point number format to a fixed-point number format, the barrel shifter 420 applies a right shift to the mantissa that is dependent upon the magnitude of the exponent.

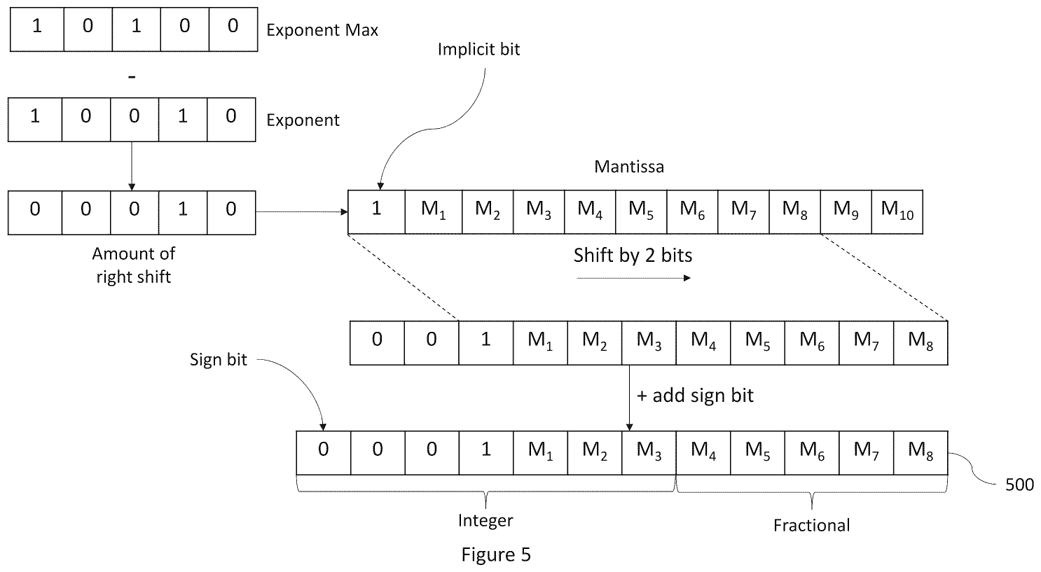

Reference is made to FIG. 5, which illustrates an example of the conversion by the barrel shifter 420 to a fixed-point number. In the example, the multiplication result, x·log 2 (e), is a half-precision FP number. The mantissa is shown as including a general set of mantissa bits, labelled as M₁ to M₁₀. The mantissa is also shown as including the implicit bit in the MSB position, which is added by the processing circuitry 310. The exponent, on the other hand, is shown as including the example set of bits 10010.

The fixed-point number to be produced contains an integer part (located prior to the binary point) and a fractional part (located after the binary point). As noted above, there is a permitted range for the exponent value in order to avoid producing an out of range exponential result. When the input is in half-precision, the condition is that the exponent of x is less than 5. Therefore, the magnitude of the integer part of x·log₂(e) must be less than log₂(e)·2⁵˜46.2, and therefore fits within 6 bits.

In FIG. 5, it is illustrated how part of the processing circuitry 310 associated with barrel shifter 420 determines the amount of right-shift to apply to the mantissa. The maximum exponent is shown represented by bits 10100. This value represents an exponent value of 5 (once the bias is subtracted) and therefore, represents the largest exponent permitted by the range condition applied by check circuitry 405. If the exponent has this maximum value, then the barrel shifter 420 does not apply any right shift to the mantissa, and the MSB of the mantissa (including the implicit bit) provides the MSB of the bit string output from the barrel shifter 420. If the exponent is less than this maximum, then the barrel shifter 420 applies right shift to the mantissa in proportion to the difference between the exponent and the maximum value of the exponent. The circuitry associated with the barrel shifter 420 subtracts the exponent value of the multiplication result x·log₂(e) from the maximum of the exponent to determine the amount of right shift to be applied. In the example of FIG. 5, the difference is equal to 2, and as shown, the mantissa is shifted by 2 bits.

After applying the right-shift to the mantissa, the circuitry 310 concatenates a further bit for representing the sign of the fixed-point number to the right-shifted mantissa, such that this further bit is the MSB of the resulting bit string. The further bit has the value 0, so as to represent a positive number. As will be described, if the sign of the input FP number is negative, this further bit is (at a later point in time) inverted to become a 1, so as to represent that the fixed-point number is negative.

As shown in FIG. 5, the result of right-shifting the mantissa and appending the sign bit is the bit string 500. The bit string 500 is used to provide a signed fixed-point number, having an integer part and a fractional part. In the case that the sign bit of the input FP is positive, the bit string 500 represents the fixed-point number. In the case, that the sign bit of the input FP is negative, the bit string 500 is subject to further processing (specifically, bit inversion operations) in order to produce the fixed-point number.

FIG. 5 shows an example bit string 500 resulting from right shifting the mantissa and concatenating the sign bit. Assuming that the sign of the input FP number is positive, this result represents the fixed-point number, which has integer and fractional parts as illustrated. The integer part comprises the sign bit followed by a number of zeros, where the number of zeros is equal to the amount of right shift applied by the barrel shifter 420. In this example, since the amount of right shift is less than number of bits of the integer part, the integer part also comprises a number of the MSBs of the mantissa. Given the addition of the sign bit, the integer part is 7 bits in length, with the sign bit as its MSB.

The fractional part has a length of l. The value of l is such that a number of the LSBs of the mantissa may be lost when the right-shift is applied to the mantissa. In the example of FIG. 5, the value of l is 5, such that when the mantissa is right-shifted by 2 bits, 2 bits of the mantissa (M₉ and M₁₀) are removed. The resulting fractional part is used as a key to reference the lookup table, and the use of a smaller number of bits for use as such a key enables the lookup table to be provided with a smaller size, i.e., fewer entries.

As noted, in the case that the sign bit of the input is negative, the bit string (e.g., bit string 500) comprising the right-shifted mantissa is subject to further processing by inverting the bits. This is done to provide an approximation of the negation of the number represented by that bit string.

Reference is made again to FIG. 4, which illustrates a set of invertors 430 for receiving the bit string (e.g., bit string 500) comprising the shifted mantissa. Each of the shifted mantissa bits output from the barrel shifter 420 is received at one of the invertors 430 and inverted. Additionally, the sign bit from the bit string is also supplied to one of the invertors 430 and inverted.

The output of the invertors 430 is the ones complement of the bit string that is input to the invertors 430. This inverted bit sequence output from the invertors 430 is an approximation of the negation of the number represented by the shifted mantissa bits plus the sign bit. This represents an approximation, since the precise conversion of a positive binary number into a negative binary number with equivalent (but negative) value is given by the twos complement of that positive binary number. The twos complement of a binary number is determined by inverting all of the bits, and then adding a value of 1 to the LSB of that result. However, to reduce the number of thread cycles required for execution of the QUEXP instruction, the addition step may be omitted, and the ones complement of the input bit string used as an approximation. The fractional part of the fixed-point number output by the invertors 430, whilst being an approximation of the correct value, is sufficiently accurate for use as a key into the look up table 450 in order to obtain an estimate for the mantissa of the exponential result.

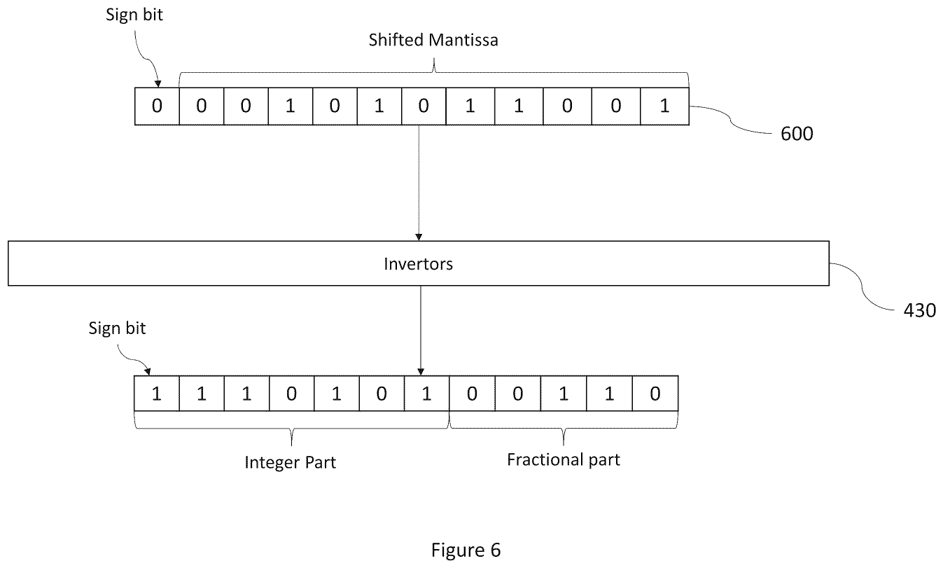

Reference is made to FIG. 6, which illustrates an example of how the invertors 430 produce the ones complement of an input bit string 600, where that input bit string comprises the shifted mantissa and the appended sign bit. This result is equal to the fixed-point number in the case that the sign bit of the input FP number is negative. An example bit sequence 600 corresponding to the shifted mantissa plus the sign bit is shown in FIG. 6. The bit sequence 600 is a possible example of bit string 500. The sign bit belonging to the bit sequence 600 is a zero which, when inverted by one of the invertors 430, is converted to a one, so as to represent that the number is a negative number. Each bit of the bit sequence 600 is provided to one of the invertors 430, so as to invert each of the bits as shown. The resulting bit sequence is the fixed-point number consisting of an integer part and a fractional part. This resulting bit sequence is an approximation of x·log₂(e), which has been rounded down to the nearest multiple of 2^{-l}.

Following on from Equation 1 above, given that the multiplication result, x·log₂(e), has been converted to a fixed-point number, having an integer part i and a fractional part f, the exponential function e^{x} can then be expressed in terms of the integer part and the fractional part as:

$${e}^{x} = {2}^{x . {log}_{2} ( e )} = {2}^{i + f} = {2}^{i} . {2}^{f} \qquad Equation 2$$

From Equation 2, it is seen that, in order to evaluate the exponential function, it is required to only separately evaluate 2ⁱ and 2^{f}. Since i is the integer part, it is used to provide the exponent of the result, whereas 2^{f} is used to provide the mantissa.

Referring again to FIG. 4, the multiplexer 440 selects between two inputs in dependence upon the value of the sign bit. If the sign bit is positive, the multiplexer 440 outputs, as the fixed-point number, the bit string comprising the shifted mantissa produced by the barrel shifter 420 with the additional sign bit. If the sign bit is negative, the multiplexer 440 instead outputs, as the fixed-point number, the ones complement of that bit string.

The fractional part is extracted from the fixed-point number and provided to the circuitry associated with the lookup table 450, which uses the fractional part as a key to search the lookup table 450. As noted, the fractional part has a bit length l, and therefore a key having l bits is used to search the lookup table. Given that the length of the fractional part is equal to l, the spacing between the keys of consecutive entries in the lookup table is 2^{-l}. The midpoint between the key, k, of one entry and the key of the next entry is therefore given by:

$$Midpoint ( k ) = k + \frac{{2}^{- l}}{2} = k + {2}^{- l - 1} \qquad Equation 3$$

Given that the true value for x·log₂(e) may be located anywhere between the value given by the key of one entry and the key of the next entry in the lookup table, the entry for that key should be taken to correspond to the value that would be produced if x·log₂(e) were equal to the midpoint between that key and the next key. Given that the lookup table 450 is designed to provide a mapping from f→2^{f}, each entry therefore provides the following output from the lookup table, given the key k:

$$Output ( k ) = {2}^{midpoint ( k )} = {2}^{k + {2}^{- l - 1}} \qquad Equation 4$$

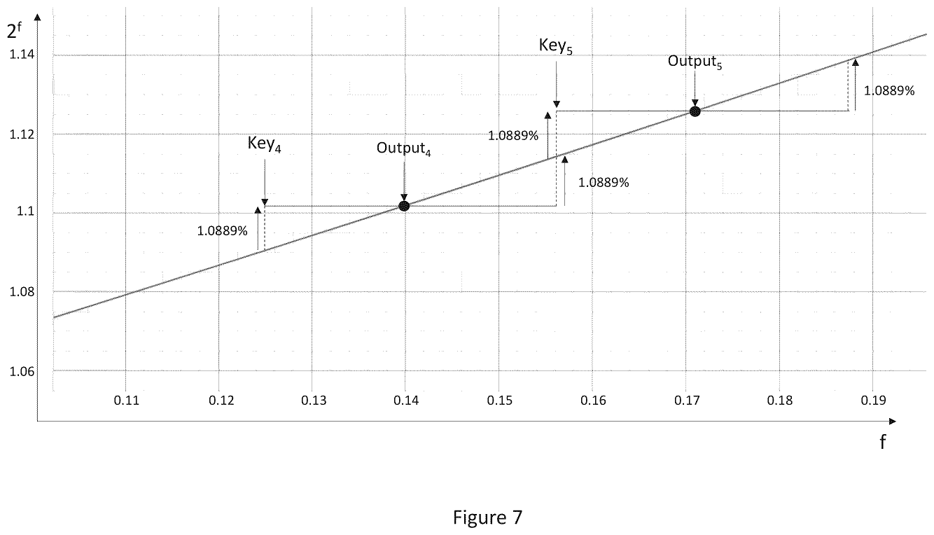

Reference is made to FIG. 7, which illustrates the function 2^{f} for a subrange of the possible values for the fractional part, f, in the case that the length, l, of the fractional part is equal to 5. The curve illustrates the true values of 2^{f}, along which are shown located two values representing output values from the lookup table. The first of these is shown as output₄ which, in the case that a 5-bit key is used for referencing the lookup table 450, belongs to the fourth entry in the lookup table 450. The second output from the look up table 450 is outputs which, in the case that a 5-bit key is used for referencing the lookup table 450, belongs to the fifth entry in the lookup table 450.

Each of the lookup table entries is referenced by a key. In FIG. 7, is shown Key₄ which, in the case that each of the keys comprises 5-bits, references the fourth entry in the lookup table. In FIG. 7, is shown Key₅ which references the fifth entry in the lookup table. Since the fractional part forming part of the key can be considered to be an approximation of a true value that is equal to or greater than the key, the key for each entry is shown at the lower bound of values of f that are covered by that entry. When a given key is used to reference the lookup table 450, the value output from the table 450 is the value of 2^{f} if f were equal to the midpoint between that given key and the next key. For example, if the fractional part received at the circuitry associated with lookup table 450 is equal to key₄, then key₄ is used to search the lookup table 450 and to obtain output₄ as the output. On the other hand, if the fractional part received at the circuitry associated with lookup table 450 is equal to keys, then keys is used to search the lookup table 450 and to obtain outputs as the output.

FIG. 7 shows the multiplicative errors (given by 2^{1/64}, which corresponds to 1.0889%, in the case that l=5) associated with the upper and lower bounds of f for each look-up table entry. For example, for the fourth entry in the look-up table, the lower bound of f is given by Key₄, whereas the upper bound of f is given by Key₅−df, where df is an infinitesimal amount. As shown in the Figure, Output₄ must be increased by 1.0889% to produce 24, when f is equal to the upper bound for the entry, and the value of 2^{f} when f is equal to the lower bound must be increased by 1.0889% to produce Output₄. Similar multiplicative errors apply for the fifth lookup table entry. Therefore, the chosen lookup table function defined by Equation 4 provides for the balancing of multiplicative errors, such that any errors resulting from the approximation of the fractional part f, do not result in a statistical bias in the results towards either 0 or infinity. Furthermore, the chosen lookup table function provides that for a particular key f, which has a finite number of bits and limited precision, used to search the lookup table, the value obtained from the lookup table is (aside from errors arising from the limited precision of the value output from the table) equal to the expected value of 2^{f} if f were provided at infinite precision. In other words, the integral over the step function obtained based on the QUEXP instruction over each step is equal to the integral of the true exponential function over the same interval.

Referring again to FIG. 4, the integer part output by multiplexer 440 is received to the subnormal check logic 460. The subnormal check logic 460 is configured to check the integer part for large negative values that are indicative of a subnormal result. In particular, if the subnormal check logic 460 determines that the integer part is less than a predefined amount (i.e., −14 for half-precision), then the subnormal check logic 460 determines that the result is subnormal. In this case, the subnormal check logic 460 also determines the difference between the predefined amount and the integer part, which indicates the amount by which the mantissa should be shifted. If the subnormal check logic 460 determines that the exponent is greater than or equal to the predefined amount (i.e., −14), then the logic 460 determines that the result is a normal number.

The integer part is also received at the logic 470, which is configured to add to the integer part, the bias for the relevant FP format. In half-precision format, this bias value is equal to 15. Adding the bias to the integer part provides the exponent of the result in the case that the result is a normal number.

Two multiplexers 480, 485 are provided for outputting the exponent and mantissa of the exponential result. Each of these is controlled to select between two inputs in dependence upon whether the result is normal or subnormal. If the subnormal check logic 460 determines that the result is subnormal, then the multiplexer 480 is controlled to output a string of zeros as the exponent. On the other hand, if the subnormal check logic 460 determines that the result is normal, the multiplexer 480 is controlled to output the exponent value determined by the circuitry 470 adding the exponent bias to the integer part.

The multiplexer 485 is also controlled in dependence upon the signal indicating whether or not the exponential result is subnormal. If the logic 460 determines that the result is normal, the multiplexer 485 is controlled to output as the mantissa of the result, the output value obtained from the lookup table 450. On the other hand, if the logic 460 determines that the result is subnormal, the multiplexer 485 is controlled to output a right-shifted version of the output value obtained from the lookup table 450. This right-shifted version of the output is produced by circuitry including the barrel shifter 490, which adds a leading one to the output of the lookup table and then applies a right-shift in proportion to the difference between the integer part and the predefined value that is determined by the logic 460.

Having produced the exponent and mantissa of the exponential result as described, the processing circuitry 310 causes these to be stored together as part of a FP number result in one of the ARFs. The processing circuitry 310 also causes a sign bit to be stored as part of this FP number, where that sign bit indicates that the FP number is positive.

The execution unit 18A in addition to be used to execute the QUEXP instruction to provide the estimate for an exponential, may also be used to perform other calculations as part of processing used for training or operating a neural network. The above-described processes for evaluating an exponential function may be used as part of this neural network processing when evaluating an activation function. In the forward pass through a neural network, the execution unit 18A may, as part of determining the activation value for a node of the neural network, sum together the input values for that node, which are received from the preceding layer in the network, and apply an activation function. Examples of activation functions requiring the evaluation of exponentials include the sigmoid, hyperbolic tangent, or softmax. The QUEXP instruction may be executed as part of the process performed by execution unit 18A for evaluating the activation function. Therefore, part of a training process for training such a neural network may be performed by the processing unit 4. As part of this training process, the processing unit 4 determines the activations for nodes of the neural network including by evaluating an exponential function using the QUEXP instruction. Having determined the activations, as part of evaluating a loss function, the processing unit 4 compares output activations of the neural network to labels included in the training data. The processing unit 4 then determines updates to weights of the neural network using the loss function and the activations, and applies the determined updates to update the weights of the neural network. It would be appreciated that the processing unit 4 would typically be one of many such processing units 4 involved in the training process and would only derive the weight updates for part of the neural network.

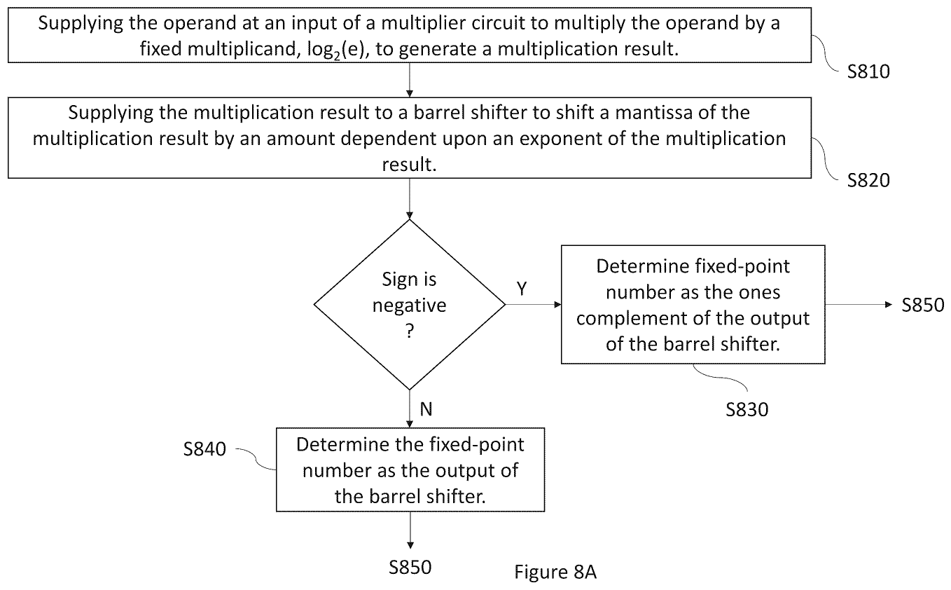

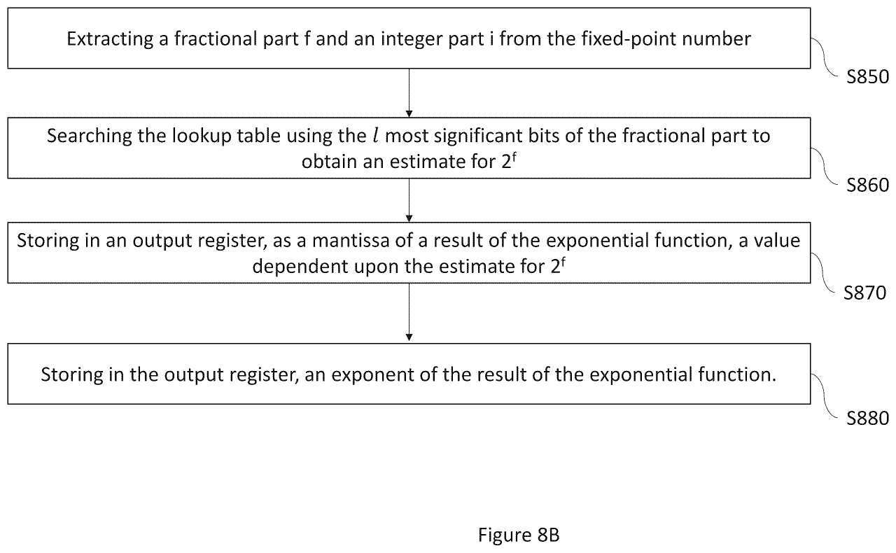

Reference is made to FIGS. 8A and 8B, which illustrates a method for evaluating an exponential function in response to the execution by the execution unit 18A of the QUEXP instruction. The evaluation of the exponential function in response to execution of the instruction may take a single processor clock cycle, i.e. it may complete in a single one of the slots shown in FIG. 9.

At S810, an operand of the QUEXP instruction is supplied as an input to the multiplier circuit 410, which is configured to multiply the operand by the fixed multiplicand, log₂(e), to generate a multiplication result.

At S820, the multiplication result is supplied to the barrel shifter 420, which is configured to shift the mantissa of the multiplication result by an amount dependent upon an exponent of the multiplication result.

If the sign of the input operand is negative, a fixed-point number is (at S830) determined as the ones complement of the output of the barrel shifter 420. This represents an approximation of the negation of the barrier shifter 420 output, which may be determined faster than determining the two complement. This faster approximation may enable the instruction execution to complete in a single processor thread cycle.

If the sign of the input operand is positive, the fixed-point number is (at S840) determined as the output of the barrel shifter 420.

Once the fixed-point number has been determined, the method progresses to S850, where the fractional part and the integer parts are extracted from the fixed-point number.

At S860, the l most significant bits (MSBs) of the fractional part are used to search the lookup table to obtain an estimate for 2^{f}. In example embodiments, l may be equal to 5.

At S870, the circuitry 310 stores in an output register, as a mantissa of a result of the exponential function, a value dependent upon the estimate for 2^{f}. The output register is a register belonging to an ARF 26A. The value dependent upon the estimate for 2^{f} may be equal to the estimate for 2^{f} (if the value is normal) or may be equal to a right-shifted version of 24 (if the value is subnormal) obtained from the barrel shifter 490.

At S880, the circuitry 310 stores in the output register, an exponent of the result of the exponential function. This exponent may be equal to the integer part (extracted at S850) with the bias added (by circuitry 470) if the result is normal. Alternatively, the exponent may be equal to a string of zeros if the result is subnormal.

The above embodiments have been described by way of example only. In particular, the embodiments have been described in terms of operations applied to an input FP number in the half-precision format to generate a result also in the half-precision format. However, the same technique may be applied for FP numbers having other formats, e.g., single-precision.

1. A processing unit comprising a hardware module for evaluating an exponential function of an operand of an instruction executed by the processing unit, the operand being a number in a floating-point format, the processing unit comprising:
a multiplier circuit configured to perform a multiplication operation;
a look up table having a plurality of entries, each of which is accessible using a respective key k to extract an output given by 2^{k+2}^{^{−l−1}}, where l is the bit length of each key;
a barrel shifter;
an output register; and
circuitry configured to:
supply the operand at an input of the multiplier circuit to multiply the operand by a fixed multiplicand, log₂(e), to generate a multiplication result;
convert the multiplication result to a fixed-point number by supplying the multiplication result to the barrel shifter to shift a mantissa of the multiplication result by an amount dependent upon an exponent of the multiplication result;
extract a fractional part f from the fixed-point number;
search the lookup table using the l most significant bits of the fractional part to obtain an estimate for 2^{f}; and
store in the output register, as a mantissa of a result of the exponential function, a value dependent upon the estimate for 2^{f}.

2. The processing unit of claim 1, wherein the value dependent upon the estimate for 2^{f} is the estimate for 2^{f}.

3. The processing unit of claim 2, wherein the hardware module comprises subnormal check logic configured to examine an integer part of the fixed-point number to determine whether the result of the exponential function is in the subnormal range,
wherein the circuitry is configured to, in response to the subnormal check logic determining that the result is not in the subnormal range, store in the output register, as the mantissa of the result, the estimate for 2^{f}.

4. The processing of claim 1, wherein the hardware module comprises subnormal check logic configured to determine that the result of the exponential function is a subnormal number in response to determining that an integer part of the fixed-point number is less than a predefined number,
wherein the hardware module comprises a further barrel shifter configured to receive the estimate for 2^{f} from the lookup table and apply right-shift to the estimate for 2^{f} in proportion to the difference between the predefined number and the integer part,
wherein the value dependent upon the estimate for 2^{f} comprises the right-shifted estimate for 2^{f}.

5. The processing unit of claim 1, wherein the circuitry is configured to:
in response to determining that a sign bit of the operand indicates that the operand is negative, determine the fixed-point number by supplying the shifted mantissa from the barrel shifter to inversion circuitry configured to invert bits of the shifted mantissa.

6. The processing unit of claim 5, wherein the circuitry is configured to determine the fixed-point number without adding one to the least significant bit of the inverted bits.

7. The processing unit of claim 1, wherein the circuitry is configured to:
in response to determining that a sign bit of the operand indicates that the operand is positive:
determine the fixed-point number by extracting the shifted mantissa from the barrel shifter.

8. The processing unit of claim 1, wherein the fixed-point number comprises a set of bits derived from the shifted mantissa and a sign bit.

9. The processing unit of claim 1, wherein the circuitry is configured to:
extract an integer part from the fixed-point number; and
store in the output register, as an exponent of the result, a value dependent upon the integer part.

10. The processing unit of claim 9, wherein the hardware module comprises addition circuitry configured to add a bias value for the floating-point format to the integer part to provide the value dependent upon the integer part.

11. The processing unit of claim 1, wherein the hardware module comprises subnormal check logic configured to examine an integer part of the fixed-point number to determine whether the result of the exponential function is in the subnormal range,
wherein the control circuitry is configured to, in response to the subnormal check logic determining that the result is in the subnormal range, store in the output register, as the exponent of the result, a string of zeros.

12. The processing unit of claim 1, wherein the hardware module is configured to process the operand to produce the exponential result in a single processor thread cycle of the processing unit.

13. The processing unit of claim 1, wherein the processing unit is configured to:
determine an input for a node of a neural network; and
apply an activation function to the input to determine an output of the node, including executing one or more instances of the instruction.

14. The processing unit of claim 1, wherein the barrel shifter is configured to shift the mantissa of the multiplication result by an amount dependent upon a difference between the exponent and a maximum exponent value that avoids overflow of the result of the exponential function.

15. The processing unit of claim 1, wherein the barrel shifter is configured to shift the mantissa of the multiplication result to produce the fixed-point number, including removing a number of least significant bits from the mantissa of the multiplication result.

16. The processing unit of claim 1, wherein the I most significant bits of the fractional part consists of fewer bits than the mantissa of the multiplication result.

17. A method for evaluating an exponential function of an operand of an instruction, the operand being a number in a floating-point format, the method comprising:
supplying the operand at an input of a multiplier circuit to multiply the operand by a fixed multiplicand, log₂(e), to generate a multiplication result;
converting the multiplication result to a fixed-point number by supplying the multiplication result to a barrel shifter to shift a mantissa of the multiplication result by an amount dependent upon an exponent of the multiplication result;
extracting a fractional part f from the fixed-point number;
searching the lookup table using the l most significant bits of the fractional part to obtain an estimate for 2^{f}, the lookup table having a plurality of entries, each of which is accessible using a respective key k to extract an output given by 2^{k+2}^{^{−l−1}}, where l is the bit length of each key; and
storing in an output register, as a mantissa of a result of the exponential function, a value dependent upon the estimate for 2^{f}.

18. The method of claim 17, wherein the value dependent upon the estimate for 2^{f} is the estimate for 2^{f}.

19. The method of claim 17, comprising processing the operand to produce the result of the exponential function in a single processor thread cycle of the processing unit.

20. The method of claim 17, comprising shifting the mantissa of the multiplication result by an amount dependent upon a difference between the exponent and a maximum exponent value that avoids overflow of the result of the exponential function.
